(19) United States
(12) Patent Application Publication
(10) Pub. No.: US 2007/0234570 A1
(43) Pub. Date: Oct. 11, 2007

(54) Method and apparatus for a carrier spider

(76) Inventor: Zhenrong Wang, Canton, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/398,954

(22) Filed: Apr. 6, 2006

(51) Int. Cl. B23P 15/14

(52) U.S. Cl. 29/893; 29/893.3; 29/893.33

(57) ABSTRACT

The present invention provides a method for producing a carrier spider. The method preferably includes providing a generally circular blank such as with a stamping operation. The blank is preferably flow-formed to form a work-hardened wall portion having a variable thickness. The variable thickness of the wall portion defines a plurality of thick sections and a plurality of thin sections. The blank is then cold-formed to form a work-hardened axially protruding core portion. Thereafter, the blank is processed to produce the carrier spider. A carrier spider apparatus is also provided.

### TECHNICAL FIELD

The present invention pertains generally to a method and apparatus for producing a carrier spider for a planetary gear set.

### BACKGROUND OF THE INVENTION

Conventional planetary gear sets typically include a carrier spider configured to rotatably support the pinion gears, and retain the pinion gear components such as bearings and washers. The carrier spider includes a splined aperture adapted to accommodate a complimentary splined shaft such that the carrier spider rotates with the shaft. The splined aperture may be subjected to relatively high loads and is therefore typically composed of a high strength material. The carrier spider also includes a plurality of legs adapted to radially retain the pinion gears.

### SUMMARY OF THE INVENTION

The method for producing a carrier spider includes providing a generally circular blank such as with a stamping operation. The blank is preferably flow-formed to form a work-hardened wall portion having a variable thickness. The variable thickness of the wall portion defines a plurality of thick sections and a plurality of thin sections. The blank is then cold-formed to form a work-hardened axially protruding core portion. Thereafter, the blank is processed to produce the carrier spider.

Processing the blank may include applying a broaching operation to the axially protruding core portion of the blank to produce a splined aperture defining a plurality of teeth.

Processing the blank may include piercing the plurality of thin sections of the wall portion to generate a plurality of windows such that the remainder of the wall portion forms a plurality of legs.

Processing the blank may include applying a punching operation to produce a plurality of mounting apertures.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of a carrier spider in accordance with the present invention;

FIG. 2 is a perspective view of a blank used to produce the carrier spider of FIG. 1;

FIG. 3 is a perspective view of the blank of FIG. 2 that has been formed using a flow-forming process; and

FIG. 4 is a perspective view of the blank of FIG. 3 that has been formed using a cold-forming process.

### DESCRIPTION OF THE PREFERRED EMBODIMENTS

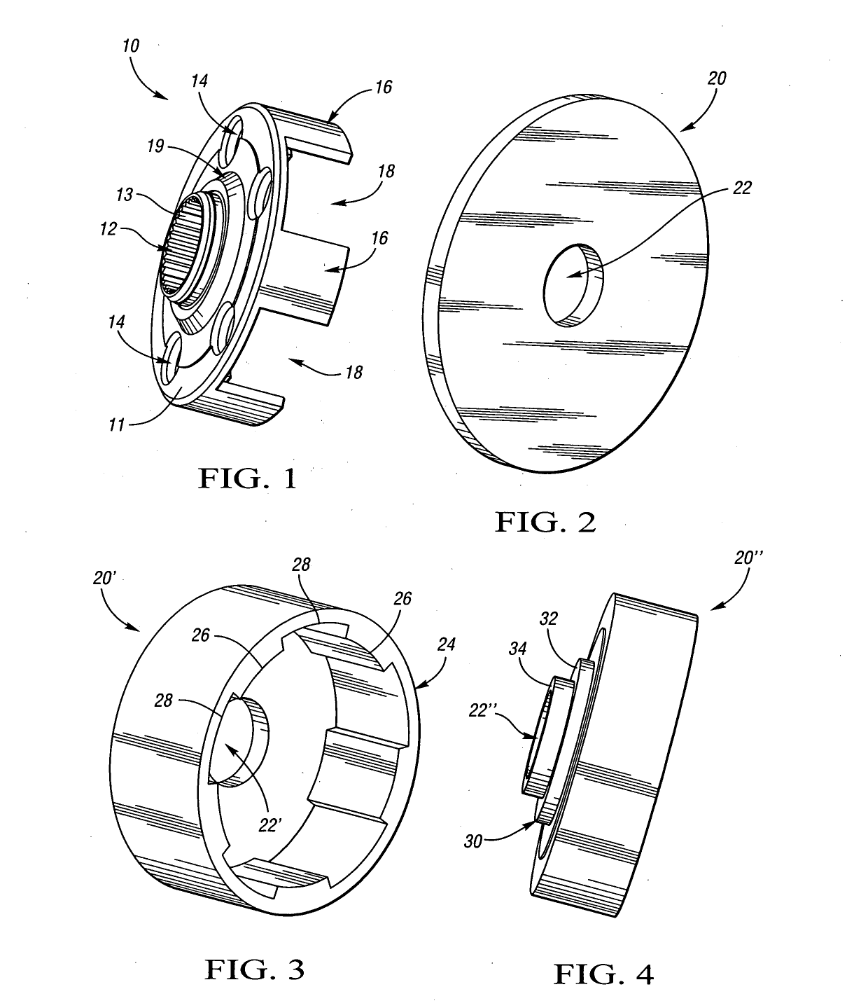

Referring to the drawings, wherein like reference numbers refer to like components, FIG. 1 shows a perspective view of a carrier spider 10 in accordance with the present invention. The carrier spider 10 includes a central hub 11. The hub 11 defines a splined aperture 12 that forms a plurality of teeth 13. The hub 11 also defines a plurality of mounting apertures 14 disposed radially around the splined aperture 12. A plurality of legs 16 extend axially from the hub 11. The legs 16 define windows 18 therebetween.

The splined aperture 12 is adapted to accommodate a complimentary splined shaft (not shown) inserted therethrough such that the carrier spider 10 and splined shaft rotate together. The plurality of mounting apertures 14 are provided to facilitate the rotatable attachment of a corresponding plurality of pinion gears (not shown) to the carrier spider 10. The legs 16 are configured to radially retain the plurality of pinion gears, and the windows 18 provide clearance for the pinion gears. Having described the apparatus of the carrier spider 10, the method of producing the carrier spider 10 will hereinafter be described.

Referring to FIG. 2, a blank 20 from which the carrier spider 10 is produced is shown. The blank 20 is a generally circular disc shape defining a central aperture 22. According to a preferred embodiment the blank 20 is composed of relatively strong low carbon steel such as, for example, 1020 steel; however alternate compositions may be envisioned. The blank 20 can be produced in any known manner such as, for example, with a stamping operation.

A flow-forming process transfers the blank 20 into a generally cylindrical blank 20′ (shown in FIG. 3). The flow-forming process is described in commonly assigned U.S. Pat. No. 5,384,949 issued to Wodrich et al., which is hereby incorporated by reference in its entirety.

Referring to FIG. 3, a perspective view of the blank 20′ is shown. The blank 20′ includes a central aperture 22′ which is identical to the central aperture 22 (shown in FIG. 2). The blank 20′ also includes a wall portion 24 from which the legs 16 (shown in FIG. 1) are ultimately produced. Advantageously, the use of the flow-forming process allows an increased wall thickness of over 9 mm as compared to a cold-forming process which is limited to approximately 7 mm. The rotational stiffness of a carrier is a design consideration and is proportional to the thickness of its carrier legs. Therefore, the additional thickness of the legs 16 afforded by the flow-forming process allows the production of a carrier spider 10 with increased rotational stiffness.

Flow-forming allows the formation of the wall portion 24 having a variable thickness. Therefore, the wall portion 24 is preferably produced with thick sections 26 that are over 9 mm thick, and thin sections 28 that are less than 3 mm thick. The thick sections 26 ultimately form the legs 16 (shown in FIG. 1), and the windows 18 (shown in FIG. 1) are pierced from the thin sections 28. The variable thickness of the wall portion 24 advantageously allows the production of thick legs 16, and also simplifies the piercing operation that produces the windows 18 by minimizing the thickness of the material through which a piercing tool must pass. Additionally, the piercing operation may be a limiting factor in the selection of the carrier spider composition such that the thinner window sections allow the implementation of higher grades of steel such as, for example, 1030 steel. In other words, it may be practical to pierce through 3 mm of 1030 steel whereas piercing through 9 mm of 1030 steel could be impossible or prohibitively expensive.

The variable thickness of the wall portion 24 allows for a material savings which also reduces cost. The material removed from the wall portion 24 during the formation of the windows 18 (shown in FIG. 1) represents excess which is generally recycled or scrapped. As the windows 18 of the present invention are pierced from the thin sections 28, less material is wasted during the piercing operation and the carrier spider 10 (shown in FIG. 1) becomes less expensive to produce.

Producing the wall portion 24 with a flow-forming process work-hardens the formed material such that the legs 16 (shown in FIG. 1) generated therefrom become stronger and more stiff. As the strength and stiffness of the legs 16 may be significant design considerations, the flow-forming process can allow for the use of less expensive materials for the carrier spider 10 (shown in FIG. 1). In other words, it may be possible to implement a less expensive material for the carrier spider 10 that would otherwise not provide the requisite leg strength and/or stiffness, but that becomes sufficiently strong and stiff after the flow-forming process.

A cold-forming process transfers the blank 20′ into the blank 20″ (shown in FIG. 4). The cold-forming process is well known to those skilled in the art and therefore will not be described in detail. It should be appreciated that the flow-forming process described hereinabove with respect to FIG. 3 and the cold-forming process described hereinafter with respect to FIG. 4 can be performed in any order.

Referring to FIG. 4, a perspective view of the blank 20″ is shown. The blank 20″ preferably includes a two-tiered axially protruding core portion 30 defining a central aperture 22″ that is larger than the central aperture 22′ (shown in FIG. 3). The central aperture 22″ becomes larger because material adjacent to the central aperture 22′ is axially drawn during the cold-forming process to produce the two-tiered core portion 30 thereby increasing the size of the central aperture 22″. The teeth 13 (shown in FIG. 1) are subsequently cut from the material adjacent to and defining the central aperture 22″ to form the splined aperture 12 (shown in FIG. 1). The two-tiered core portion 30 preferably includes a first tier or stepped portion 32 and a second tier or stepped portion 34.

The process of cold-forming the blank 20′ (shown in FIG. 3) to produce the core portion 30 work-hardens the formed material such that the material defining the central aperture 22″ becomes stronger. The teeth 13 (shown in FIG. 1) are cut from the material defining the central aperture 22″ and therefore are stronger because of the cold-forming process. The teeth 13 may be subjected to relatively high loads such that the additional strength may improve the durability of carrier spider 10 (shown in FIG. 1). Additionally, the cold-forming process can allow for the use of less expensive materials for the carrier spider 10 (shown in FIG. 1). In other words, it may be possible to implement a less expensive material for the carrier spider 10 that would otherwise not provide the requisite tooth strength, but that becomes sufficiently strong after the cold-forming process.

After the blank 20″ is completed, additional machining and/or processing steps are performed to produce the carrier spider 10. The type of steps and the order in which they are performed may be varied to meet the needs of a particular application. As an example, the splined aperture 12 (shown in FIG. 1) may be produced from the central aperture 22″ with a broaching operation, the mounting apertures 14 may be punched, the windows 18 may be pierced, and the first stepped portion 32 may be machined to provide the tapered surface 19 (shown in FIG. 1); however, it should be appreciated that any known processes may alternatively be implemented.

While the best modes for carrying out the invention have been described in detail, those familiar with the art to which this invention relates will recognize various alternative designs and embodiments for practicing the invention within the scope of the appended claims.

1. A method for producing a carrier spider comprising:
providing a generally circular blank;
flow-forming the blank to form a wall portion;
cold-forming the blank to form an axially protruding core portion; and
processing the blank to produce the carrier spider.

2. The method of claim 1, wherein said flow-forming the blank to form a wall portion includes flow-forming the blank to form a wall portion having a thickness greater than 7 mm.

3. The method of claim 1, wherein said flow-forming the blank to form a wall portion includes flow-forming the blank to form a wall portion having a variable thickness.

4. The method of claim 1, wherein said flow-forming the blank to form a wall portion includes flow-forming the blank to form a work-hardened wall portion with increased strength and stiffness.

5. The method of claim 1, wherein said cold-forming the blank to form an axially protruding core portion includes cold-forming the blank to form a work-hardened axially protruding core portion with increased strength.

6. The method of claim 1, wherein said processing the blank includes applying a broaching operation to the axially protruding core portion of the blank to produce a splined aperture defining a plurality of teeth.

7. The method of claim 6, wherein said processing the blank includes piercing predefined sections of the wall portion of the blank to generate a plurality of windows such that the remainder of the wall portion forms a plurality of legs.

8. The method of claim 7, wherein said processing the blank includes applying a punching operation to the blank to produce a plurality of mounting apertures.

9. The method of claim 8, wherein said providing a generally circular blank includes implementing a stamping operation to produce the generally circular blank.

10. A method for producing a carrier spider comprising:
providing a generally circular blank;
flow-forming the blank to form a work-hardened wall portion having a variable thickness, said wall portion defining a plurality of thick sections and a plurality of thin sections;
cold-forming the blank to form a work-hardened axially protruding core portion; and
processing the blank to produce the carrier spider.

11. The method of claim 10, wherein said flow-forming the blank to form a work-hardened wall portion includes flow-forming the blank to form a work-hardened wall portion defining a plurality of thick sections that are more than 7 mm thick.

12. The method of claim 11, wherein said processing the blank includes applying a broaching operation to the axially protruding core portion of the blank to produce a splined aperture defining a plurality of teeth.

13. The method of claim 12, wherein said processing the blank includes piercing the plurality of thin sections of the wall portion to generate a plurality of windows such that the remainder of the wall portion forms a plurality of legs.

14. The method of claim 13, wherein said processing the blank includes applying a punching operation to the blank to produce a plurality of mounting apertures.

15. The method of claim 14, wherein said providing a generally circular blank includes implementing a stamping operation to produce the generally circular blank.

16. A carrier spider comprising:
a hub;
a splined aperture defined by the hub, said splined aperture forming a plurality of teeth;
a plurality of mounting apertures defined by the hub; and
a plurality of legs extending in an axial direction from the hub, said plurality of legs being at least approximately 7.5 mm thick.

17. The carrier spider of claim 16, wherein said plurality of legs are at least approximately 9 mm thick.

18. The carrier spider of claim 17, further comprising a plurality of windows defined by said plurality of legs.
